(19) United States
(12) Patent Application Publication
(10) Pub. No.: US 2023/0340831 A1
(43) Pub. Date: Oct. 26, 2023

(54) REMOTE MONITORING AND CONTROL OF MOVABLE BARRIER STATUS IN SYSTEM INCORPORATING RESIDENTIAL JACKSHAFT DOOR OPERATOR

(71) Applicant: GMI Holdings, Inc., Mt. Hope, OH (US)

(72) Inventors: Tim Ikeler, Alliance, OH (US); LeRoy G. Krupke, Carrollton, TX (US); Brent Buescher, Wooster, OH (US); Brent Alan Rauscher, Keller, TX (US); Michael Dragomier, North Canton, OH (US)

(21) Appl. No.: 18/342,259

(22) Filed: Jun. 27, 2023

Related U.S. Application Data
(63) Continuation of application No. 16/395,075, filed on Apr. 25, 2019.
(60) Provisional application No. 62/662,701, filed on Apr. 25, 2018.

(51) Int. Cl. E05F 15/77; E05F 15/60; E05F 15/79; G08C 17/00

(52) U.S. Cl. CPC E05F 15/77; E05F 15/60; E05F 15/79; G08C 17/00; G08B 5/36

(57) ABSTRACT

Remote garage door monitoring and control apparatus consisting of a jackshaft type garage door opener in combination with an integrated door control module for monitoring and wireless transmission of garage door positional status as well as processing received remotely generated change-of-positional door status commands. Incorporated is an absolute position encoder for generating signals corresponding to the extent and direction of rotation of the jackshaft, and therefore corresponding to the extent and direction of movement of the garage door. A Bluetooth short range wireless communication assembly incorporated with the apparatus enables the nature of the actuation of work light in a manner dependent upon whether the incoming door commands are remotely or proximately generated.

### CROSS REFERENCE TO RELATED APPLICATION

This application claims the benefit of U.S. Provisional Application No. 62/662,701 titled “REMOTE MONITORING AND CONTROL OF MOVABLE BARRIER STATUS IN SYSTEM INCORPORATING RESIDENTIAL JACKSHAFT DOOR OPERATOR”, filed Apr. 25, 2018, which is hereby incorporated by reference in its entirety for all purposes.

### TECHNICAL FIELD

The present disclosure relates to the field of remote network monitoring and control of movable barrier apparatus, more particularly to the remote monitoring and control, via the Internet, of garage door openers, and even more particularly to the remote monitoring and control, via the Internet, of garage door openers that incorporate a jackshaft door operator drive assembly.

### BACKGROUND

Movable barriers, such as upward-acting sectional or single panel garage doors, residential and commercial rollup doors, and slidable and swingable gates, are used to alternatively allow and restrict entry to building structures and property. These barriers are typically driven between their respective open and closed positions by movable barrier openers, which in the specific case of a garage door, are “garage door openers”, which respectively include motors and associated motor drive assemblies, which are themselves controlled by “garage door operators.” Garage door operators are effective to cause the motor, and the associated motor drive assembly, to move the connected garage door, typically between its fully open and closed positions.

Each garage door operator includes a door controller (typically, a microprocessor, microcontroller, programmable logic or gate array or other programmable platform) for processing incoming door commands and generating output control signals to the motor which, in combination with its associated motor drive assembly, moves the garage door in accordance with the incoming door commands. The incoming door commands, in the past, have been in the form of wired or wireless signals transmitted from interior or exterior wall consoles, or from proximately located hand held or vehicle mounted RF transmitters.

However, with the near ubiquity of the Internet and the proliferation of electronic devices and equipment designed to access the Internet, such as personal computers, cellphones, and Smartphones, garage door opener systems are currently being designed and implemented in the trade that enable non-proximate, or remote, monitoring and control, via the Internet, of door status. For example, if a homeowner is not in proximity to its residence, and wants to determine whether the garage door the homeowner had intended to close, did in fact close, or whether the garage door it intended to leave open for a workman to enter, had in fact been left open, using one of these systems, the homeowner can, through access to the Internet, remotely monitor the status of the garage door (e.g., whether it is open or closed). Moreover, if the garage door is not in the desired position, these systems are designed to also enable the homeowner to transmit change-of-door status commands over the Internet to cause the garage door opener to move the garage door to the desired position, all without having to be physically proximate the garage to do so.

Particular challenges have been encountered when the motor drive assembly is of the type known in the industry as a jackshaft drive assembly. As conventionally known, a jackshaft drive assembly is one in which, typically, the motor is directly coupled to a horizontally positioned shaft (i.e., the jackshaft) extending along the width of, and mounted above, the movable barrier, one or more cable drum(s) rigidly attached to the jackshaft. One or more cables are wound about the cable drum(s) with the free end of each cable connected to, and at the lower end of, the movable barrier. When the motor is actuated to open the door, the jack shaft and the cable drum(s) are consequently rotated in a direction so as to wind the cable(s) on to the cable drum(s), thereby lifting the movable barrier to its open position. When the motor is actuated to close the door, the jackshaft and the cable drum(s) are consequently rotated in an opposite direction so that the cable(s) may be payed out, thereby permitting the movable barrier to be closed by the combination of the restoring force provided by a torsion spring wound around the jackshaft and the unsupported portion of the weight of the movable barrier.

One of the requirements that must be met in connection with a remotely generated door command is to actuate a flashing light and sound warning sufficiently in advance of the impending unattended door movement to warn anyone who may be in the path of the door travel. However, due to the inherent design of the jackshaft drive assembly, the warning light and sounder must be separately mounted from the drive assembly while at the same time being in effective bi-directional communication with the garage door opener. In addition, accurate monitoring of the position of the door requires that an appropriate sensor be provided that effectively and accurately interconnect the jackshaft drive assembly with the monitoring portion of the system.

### SUMMARY

In accordance with the aforementioned and other objectives, disclosed herein is remote monitoring and control apparatus comprising a jackshaft type garage door opener in combination with an integrated door control module (iDCM), the iDCM enabling the user to (i) monitor and remotely transmit, via the Internet, the positional door status (e.g., the “open”/closed” status) of the user's garage door, and (ii) receive and process change-of-positional door status commands remotely transmitted, via the Internet, to activate the garage door opener to move the garage door to the position instructed by the change-of-positional door status commands.

In accordance with a unique feature of the herein described monitoring and control apparatus, an absolute position encoder (APE) is operatively coupled with the motor driven rotating jackshaft to generate an output signal corresponding to the extent and direction of such rotational movement, and therefore corresponding to the extent and direction of movement of the garage door. These positional signals are then routed to the iDCM, specifically a first microprocessor of the iDCM, which microprocessor has been preprogrammed to sequentially (i) determine, from multiple open/close cycles of the garage door, the location of the fully closed travel limit of the garage door, (ii) then, when garage door movement thereafter ceases, determine whether the garage door is sufficiently close to such lower travel limit to be deemed “closed”, or if not sufficiently close to the lower travel limit, to be deemed “not closed” (i.e., “open”), and (iii) finally, generate digital door status output signals corresponding to either the “closed” or “open” status of the garage door. These digital door status signals are subsequently routed for wireless transmission of the “open” or “closed” positional door status to the desired remote location.

In accordance with another unique feature of the monitoring and control system, the jackshaft door opener is in bi-directional wireless communication with a work light and sounder assembly. This communication is established by way of a short-range wireless interconnection assembly, preferably using the Bluetooth standard, comprising a host module and a fixture in which the work light and sounder are mounted. The host module is configured and programmed to transmit wireless instructions to the fixture to activate the work light and/or the sounder in a manner depending upon whether the incoming positional door status command is remotely or proximately generated. Remotely generated door commands result in instructions to flash the work light and activate the warning sound for a pre-determined time period in advance of the impending unattended garage door movement. Proximately user-generated door commands result in instructions to the fixture to merely turn the work light on (or off). The garage light/sounder fixture is configured and programmed to wirelessly transmit an acknowledge signal to the host module confirming receipt of the wireless instructions from the host module. The absence of this acknowledge signal during the processing of the remotely generated door status command preventing the unattended garage door movement.

### BRIEF DESCRIPTION OF THE DRAWINGS

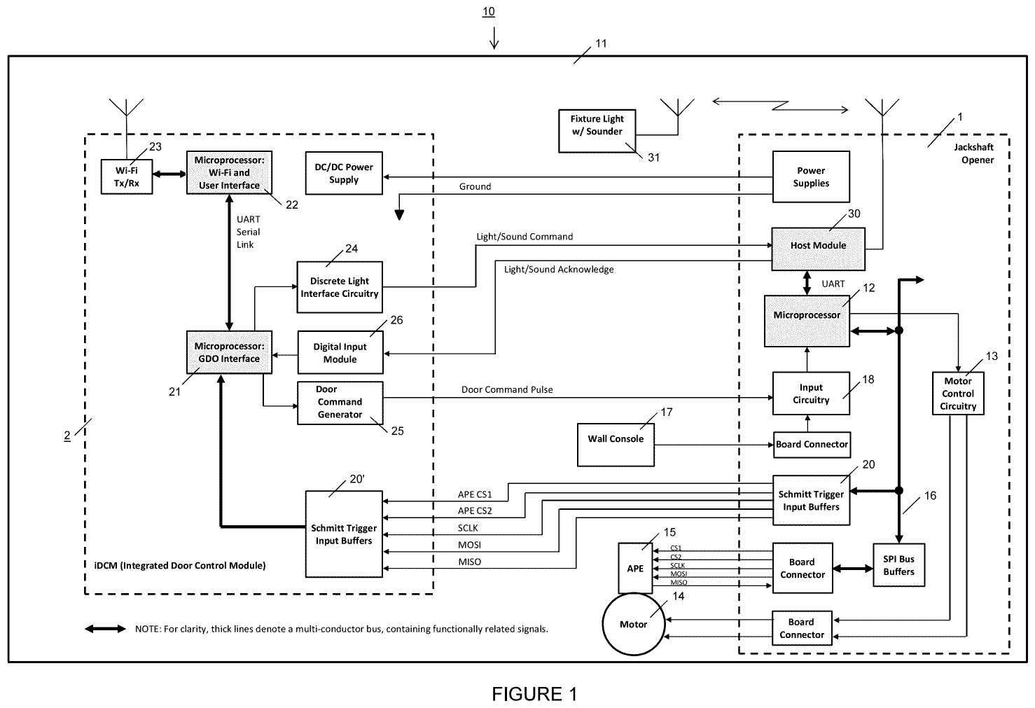

Additional features of the herein described method and apparatus will become readily understood from the following detailed written description, taken in conjunction with the appended drawing, in which the sole figure, FIG. 1, is a block diagram schematic of the remote monitoring and control apparatus in accordance with the principles of the present invention.

### DETAILED DESCRIPTION

An embodiment of the remote movable barrier status monitoring and control system in accordance with the principles of the present invention will be described below. This described embodiment is only a non-limiting example of implementation of the invention as defined solely by the attached claims.

With initial reference now to FIG. 1, there is depicted a detailed block diagram schematic of a preferred embodiment of the garage door monitoring and control system 10 of the present invention located within power head chassis 11. The system 10 comprises (i) the jackshaft garage door opener 1 (material components of which are principally located within the dotted lines at the right side of the block diagram schematic) and (ii) the integrated door control module 2 (material components of which are principally located within the dotted lines at the left side of the block diagram schematic).

The jackshaft garage door opener 1 is configured to control the movement of the associated garage door (not shown) in accordance with both remotely generated and proximately generated positional door status commands. Material components of the garage door opener 1 include garage door operator controller 12, motor control circuitry 13, and DC motor 14. The garage door operator controller 12 preferably comprises a programmable microprocessor for processing incoming positional door status commands, both remotely generated and proximately generated, and, in response, generating output control signals to the motor 14, via the motor control circuitry 13, to move the garage door in accordance with the incoming commands.

The integrated door control module 2 is configured to (i) monitor the status of the garage door, specifically whether it is “open” or “closed”, and wirelessly transmit such status to the desired remote location, as well as (ii) processing received remotely generated change-of-positional door status commands to actuate the jackshaft opener 1 to move the garage door in accordance with such commands after activating a warning, in the manner subsequently described, of the impending unattended garage door movement.

Proximately generated positional door status commands, for example as a result of user-activation of wall console 17, are inputted to controller 12 via input circuitry 18. As subsequently described, the remotely generated door command pulse is also inputted to controller 12 via input circuitry 18.

In accordance with a unique feature hereof, a short range wireless communication assembly, comprising a host module 30 and fixture 31, in bidirectional wireless communication with one another, is an integral part of the overall system 10. While various wireless standards may be employed to effect this wireless communication, the Bluetooth® standard is preferred for this embodiment. Fixture 31, incorporating a programmable microprocessor and wireless transceiver, and so constructed to retain an electrically actuable work light and warning sounder, is adapted to actuate the work light 1 and warning sounder in response to, and in accordance with the nature and content of, an incoming wireless instruction signal transmitted from host module 30. In response to the receipt by the fixture 31 of such incoming wireless instruction signal, an acknowledge signal is wirelessly transmitted from the fixture 31 to the host module 30, confirming receipt of the transmitted instruction signal.

As shown in FIG. 1, host module 30 is also mounted in bidirectional conductive relationship (via UART link) with controller 12 and, incorporating its own programmable microprocessor and wireless transceiver, transmits the appropriate instruction signal to the fixture 31. As subsequently described, the nature and content of the instruction signal depends upon whether the door status command is being proximately generated (i.e., from a location in which the area surrounding the garage is in safe view of the user activating the command) or is being remotely generated out of such safe view (so as to make the impending door movement unattended.)

Referring to FIG. 1, there is now described the operation of the system 10. An absolute position encoder (APE) 15 is operatively coupled with the motor 14 and, in particular, the interconnected motor driven jackshaft. Accordingly, the encoder 15, being monitored by controller 12 via an industry standard Serial Peripheral Interface Bus (SPI Bus)16, generates positional data output signals (designated in FIG. as “MISO” signals) corresponding to the extent and direction of rotation of the motor driven jackshaft, and therefore corresponding to the extent and direction of movement of the garage door.

The MISO positional data output signals are subsequently routed to the SPI Bus 16, the SPI Bus 16 routing the MISO data signals through input buffers 20 and 20′, where the buffered positional data signals are thereafter routed to the input of an initial programmable microprocessor 21 of the integrated door control module 2.

In accordance with the process subsequently described, the MISO positional data signals are then processed by microprocessor 21, pursuant to the hereinafter described programmable-controlled operation, to produce digital door status signals indicative of the “open” or “closed” status of the garage door. This programmed-controlled operation proceeds in three sequential steps, namely (i) an initial determination, based upon multiple open/close cycles of the garage door between fully open and fully closed positions, of the location of the fully closed garage door travel limit, (ii) thereafter, after the garage door movement stops, a determination whether the halted door is within a preset distance from the fully closed position to be considered “closed” and, if not, to be considered “not closed” (i.e., “open”), and (iii) the generation of digital door status signals at the output of microprocessor 21 corresponding to either the “closed” or “open” status of the garage door.

The so-generated digital door status signals are then transmitted from microprocessor 21, by way of UART serial link, to microprocessor 22 (in the direction of the upwardly pointed arrow) for initial storage and WiFi conditioning, and thereafter transmission to Wi-Fi transceiver 23 where, in its transmission mode, the transceiver wirelessly transmits the door status information, for example via the Internet, to a designated remote location, along with an identifier unique to the iDCM.

The transceiver 23, in its receiving mode, is also effective to receive remotely generated wireless change-of-positional door status commands, each such command then routed to microprocessor 22. After the change-of-positional door status command is compared with any door status information previously stored in microprocessor 22, to assure that the requested door status made the subject of the incoming command is not already the existing status, the requested positional door status command is then routed by microprocessor 22 (now, in the direction of the downwardly pointed arrow) to microprocessor 21.

The microprocessor 21, upon receipt of such remotely generated requested positional door status command, activates the discrete light interface circuitry 24 to generate a Light/Sound Command signal pulse. This Light/Sound Command pulse is conductively routed to the host module 30 that, in response, wirelessly instructs the fixture 31 to activate the work light to begin flashing and the sounder to emit a warning sound. The flashing light and warning sound continue for a predetermined warning period of time necessary to provide sufficient advance notice of the impending unattended garage door movement. In the meantime, the acknowledge signal, which had been transmitted from the fixture 31 to the host 30 in confirmation of receipt of the instruction signal from the host 30, is conductively routed, via digital input module 26, to programmable microprocessor 21, for the purpose subsequently described.

After a predetermined time delay after the microprocessor 21 activated the Light/Sound Command, the time delay being preferably at least as long as the aforementioned flashing light and sounder advance warning time, microprocessor 21 automatically activates the door command generator 25 to generate a door command pulse that is conductively routed, via input circuitry 18, to garage door operator processor 12, thereby actuating the processor to operate the motor to move the garage door in accordance with the requested positional door status command. However, and in accordance with another unique feature of the described system 10, should the Light/Sound Acknowledge signal not be received by microprocessor 21 during the aforementioned predetermined delay period (potentially because fixture 31 had not been activated), the microprocessor is programmed to not generate the door command pulse.

Further with respect to the Bluetooth wireless communication assembly, the fixture 31 is adapted to be mounted in any convenient location in the garage and includes sockets or the like for retaining (i) a work light of desired intensity and longevity and (ii) a sounder alarm of sufficient volume.

When responding to requested door commands that have been remotely generated by a user not in full view of the garage area, or automatically generated without user participation, after the host module 30 and fixture 31 are appropriately paired, the host module 30 will generate the wireless instruction signal to actuate the fixture 31 to flash the work light and sound the alarm for the duration and rate compliant with UL 325. On the other hand, when responding to requested door commands that are locally or proximately user-generated, such as door commands user-generated from the wall console 17, after the host module 30 and the fixture 31 are appropriately paired, the host module 30 will generate a wireless instruction signal to actuate the fixture 31 to only turn on the work light in connection with the garage door movement. Thus, the microprocessor in the Bluetooth host module 30 is programmed to distinguish between the remotely generated door commands and the proximately generated door commands in order to send the appropriate instructions to the fixture 31.

Further with respect to the encoder 15, a typical absolute position encoder (APE) consists of two gear wheels directly coupled together to form a gear train. One of the two gear wheels may have 30 teeth, and the second gear wheel may have 29 teeth. This gear train will then typically be coupled to a 60 tooth gear affixed to the output shaft (the “jackshaft”) of the door opener. Each of the two gear wheels of the absolute position encoder has a magnet, in a fixed orientation, permanently attached to its respective gear wheel such that each magnet rotates at the same angular rate as its respective gear wheel.

During the rotation of the jackshaft, and the consequent rotation of the two gear wheels, the angular displacement of each magnet is measured by a pair of Hall effect angle sensors. By arithmetically combining the two angle values, the position of the rotating jackshaft (and therefore the position of the garage door) can be continuously determined, with this garage door position information represented by the output signal MISO.

The Hall effect angle sensors in the APE make their measured angle data information available through the operation of the SPI Bus 16. Specifically, the SPI Bus 16 is a multi-drop synchronous serial communications bus in a master/slave configuration. The controller 12 functions as the master periodically appropriately querying the pair of Hall effect angle sensors through use of incoming slave clocking signals SCLK, data signals MOSI, and dedicated enable (address) signals CS1 and CS2 respectively for each angle sensor. These same signals are routed, along with output data signal MISO, through the two input buffers 20 and 20′ to respectively minimize additional loading on the SPI Bus 16 and minimize the effects of noise pick-up over the cables routing the signals from the jackshaft opener board to the IDCM board.

Various modifications may be made to the disclosed embodiment without departing from the principles of the present invention. For example, while the disclosure references the use of microprocessors for carrying out the respective programmable functions, one may also use an alternative programmable platform for such functions, including a microcontroller, programmable logic or gate array, or the like, that can be readily programmed to perform the functions set forth herein.

Moreover, those skilled in the art, having the benefit of this disclosure, will appreciate that other embodiments can be envisioned that do not depart from the spirit and scope of the invention as defined solely by the attached claims, and equivalents thereof.

1-9. (canceled)

10. A remote barrier status monitoring and control system, comprising:
a jackshaft motor drive assembly including an output shaft;
a barrier operator controller having a first processor configured to control the jackshaft motor drive assembly;
an absolute position sensor coupled to the output shaft of the jackshaft motor drive assembly for providing a signal output corresponding to a position of a barrier to the barrier operator controller; and
an integrated door control module, including a second processor, configured to receive the signal output from the barrier operator controller at the second processor and to transmit, via the Internet, the position of the barrier to a remotely located Internet access device.

11. The remote barrier status monitoring and control system of claim 10, further comprising:
a light/sounder fixture configured to transmit an acknowledge signal for receipt by the integrated door control module to confirm receipt of an instruction to at least one of flash a light or emit a sound.

12. The remote barrier status monitoring and control system of claim 11, wherein the integrated door control module is configured to generate the instruction to the light/sounder fixture.

13. The remote barrier status monitoring and control system of claim 12, further comprising a host module in operative communication with the first processor and configured to receive the instruction from the integrated door control module and to transmit the instruction to the light/sounder fixture.

14. The remote barrier status monitoring and control system of claim 13, wherein the host module is configured to receive the instruction from the integrated door control module without the instruction being received at the first processor.

15. The remote barrier status monitoring and control system of claim 13, wherein the host module is a Bluetooth communication module.

16. The remote barrier status monitoring and control system of claim 12, wherein the light/sounder fixture is configured to flash the light or emit the sound for a predetermined period of time.

17. The remote barrier status monitoring and control system of claim 16, wherein the integrated door control module is configured to transmit a barrier command pulse to the barrier operator controller to cause the barrier operator controller to move the barrier, wherein the integrated door control module is configured to delay transmission of the barrier command pulse to the barrier operator controller for a defined period of time after the transmission of the instruction to at least one of flash the light or emit the sound.

18. The remote barrier status monitoring and control system of claim 17, wherein the defined period of time is at least as long as the predetermined period of time.

19. The remote barrier status monitoring and control system of claim 11, wherein the integrated door control module is configured to prevent transmission of the barrier command pulse when the acknowledge signal is not received.

20. The remote barrier status monitoring and control system of claim 10, wherein the absolute position sensor comprises:
at least one gear wheel;
a magnet attached to the at least one gear wheel; and
at least one angle sensor configured to measure angular displacement of the at least one gear wheel.

21. The remote barrier status monitoring and control system of claim 20, wherein the absolute position sensor is configured to continuously determine the position of the barrier during rotation of the output shaft.

22. The remote barrier status monitoring and control system of claim 10, wherein the integrated door control module further includes a third processor in operative communication with a transceiver to transmit the position of the barrier to the remotely located Internet access device.

23. The remote barrier status monitoring and control system of claim 22, wherein the second processor is configured to produce a digital barrier status signal based on the received signal output from the barrier operator controller and to transmit the digital barrier status signal to the third processor.

24. A remote barrier status monitoring and control system, comprising:
a barrier opener including:
a motor drive assembly;
a barrier operator controller having a first processor configured to control the motor drive assembly;
a position sensor coupled to an output shaft of the motor drive assembly, the position sensor generating a signal output corresponding to a position of a barrier;
an integrated door control module, including a second processor and a third processor, configured to:
receive the signal output at the second processor;
generate a digital barrier status signal based on the signal output at the second processor; and
transmit, via the Internet, the digital barrier status signal to a remotely located Internet access device; and
a chassis housing the barrier opener and the integrated door control module.

25. The remote barrier status monitoring and control system of claim 24, wherein the integrated door control module is configured to generate an instruction for a light/sounder fixture to at least one of flash a light or emit a sound.

26. The remote barrier status monitoring and control system of claim 25, further comprising the light/sounder fixture, wherein the light/sounder fixture is configured to transmit an acknowledge signal for receipt by the integrated door control module to confirm receipt of the instruction.

27. The remote barrier status monitoring and control system of claim 25, wherein the barrier opener further comprises a host module in operative communication with the first processor and configured to receive the instruction from the integrated door control module and to transmit the instruction to the light/sounder fixture.

28. The remote barrier status monitoring and control system of claim 25, wherein the integrated door control module is configured to transmit a barrier command pulse to the barrier operator controller to cause the barrier operator controller to move the barrier, wherein the integrated door control module is configured to delay transmission of the barrier command pulse to the barrier operator controller for a defined period of time after the transmission of the instruction to at least one of flash the light or emit the sound.

29. The remote barrier status monitoring and control system of claim 28, wherein the defined period of time is at least as long as a predetermined period of time during which the light/sounder fixture is configured to flash the light or emit the sound.
